(19) United States
(12) Patent Application Publication
(10) Pub. No.: US 2019/0132771 A1
(43) Pub. Date: May 2, 2019

(54) Buffer Status Report For Split Bearer Preprocessing In Wireless Communications

(71) Applicant: MediaTek Inc., Hsinchu City (TW)

(72) Inventors: Yu-Syuan Jheng, Hsinchu City (TW); Pavan Santhana Krishna Nuggehalli, San Jose, CA (US); Chun-Fan Tsai, Hsinchu City (TW); Chia-Chun Hsu, Hsinchu City (TW)

(21) Appl. No.: 16/177,427

(22) Filed: Nov. 1, 2018

Related U.S. Application Data
(60) Provisional application No. 62/579,932, filed on Nov. 1, 2017.

(51) Int. Cl. H04W 28/08; H04W 28/02; H04W 76/15

(52) U.S. Cl. CPC H04W 28/085; H04W 76/15; H04W 28/0278; H04W 28/0252

(57) ABSTRACT

A user equipment (UE) compares a total amount of data available for transmission, including a total amount of packet data convergence protocol (PDCP) data volume and radio link control (RLC) data volume pending for initial transmission in two associated RLC entities comprising a primary RLC entity and a secondary RLC entity, to a threshold. In response to the total amount of data available for transmission being less than the threshold, the UE indicates an amount of the PDCP data volume to a first medium access control (MAC) entity associated with the primary RLC entity as well as indicating zero to a second MAC entity associated with the secondary RLC entity. In response to the total amount of data available for transmission being greater than or equal to the threshold, the UE indicates the amount of the PDCP data to both the first MAC entity and the second MAC entity.

### CROSS REFERENCE TO RELATED PATENT APPLICATION(S)

The present disclosure is part of a non-provisional application claiming the priority benefit of U.S. Patent Application No. 62/579,932, filed on 1 Nov. 2017, the content of which is incorporated by reference in its entirety.

### TECHNICAL FIELD

The present disclosure is generally related to wireless communications and, more particularly, to buffer status report for split bearer preprocessing in wireless communications.

### BACKGROUND

Unless otherwise indicated herein, approaches described in this section are not prior art to the claims listed below and are not admitted as prior art by inclusion in this section.

Under current specification of 3^{rd}-Generation Partnership Project (3GPP) for layer 2 and layer 3 radio resource (RAN2), it is agreed that layer 2 (L2) preprocessing will be introduced in 5^{th}-Generation (5G) New Radio (NR) mobile communications to satisfy requirement of high data rate. There are, however, some remaining issues in dual connectivity with respect to preprocessing.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method may involve preprocessing data. The method may also involve comparing a total amount of data available for transmission, including a total amount of packet data convergence protocol (PDCP) data volume and radio link control (RLC) data volume pending for initial transmission in two associated RLC entities comprising a primary RLC entity and a secondary RLC entity, to a threshold. The method may further involve performing either a first procedure, responsive to the comparing showing the total amount of data available for transmission being less than the threshold, or a second procedure, responsive to the comparing showing the total amount of data available for transmission being greater than or equal to the threshold. The first procedure may involve indicating an amount of the PDCP data volume to a first medium access control (MAC) entity associated with the primary RLC entity. The first procedure may also involve indicating zero to a second MAC entity associated with the secondary RLC entity. The second procedure may involve indicating the amount of the PDCP data volume to both the first MAC entity and the second MAC entity.

In one aspect, a method may involve determining a total amount of data available for transmission, which may include a total amount of PDCP data volume and RLC data volume pending for initial transmission in two associated RLC entities comprising a primary RLC entity and a secondary RLC entity. The method may also involve comparing the total amount of data available for transmission to a threshold. The method may further involve reporting to a network node of a mobile communication system to indicate that there is data for transmission to a first cell group and there is no data for transmission to a second cell group, in response to the total amount of data available for transmission less than the threshold. Alternatively, the method may involve reporting to the network node to indicate that there is data for transmission to both the first cell group and the second cell group, in response to the total amount of data available for transmission greater than or equal to the threshold.

In one aspect, an apparatus may include a transceiver and a processor coupled to the transceiver. The transceiver may be capable of wirelessly communicating with a mobile communication system. The processor may be capable of: (1) preprocessing data; (2) comparing a total amount of data available for transmission, including a total amount of PDCP data volume and RLC data volume pending for initial transmission in two associated RLC entities comprising a primary RLC entity and a secondary RLC entity, to a threshold; and (3) performing either a first procedure, responsive to the comparing showing the total amount of data available for transmission being less than the threshold, or a second procedure, responsive to the comparing showing the total amount of data available for transmission being greater than or equal to the threshold. In executing the first procedure, the processor may be capable of: (a) indicating an amount of the PDCP data volume to a first MAC entity associated with the primary RLC entity; and (b) indicating zero to a second MAC entity associated with the secondary RLC entity. In executing the second procedure, the processor may be capable of indicating the amount of the PDCP data volume to both the first MAC entity and the second MAC entity.

It is noteworthy that, although description provided herein may be in the context of certain radio access technologies, networks and network topologies such as 5G NR, the proposed concepts, schemes and any variation(s)/derivative(s) thereof may be implemented in, for and by other types of radio access technologies, networks and network topologies (e.g., Long-Term Evolution (LTE), LTE-Advanced, LTE-Advanced Pro, Internet-of-Things (IoT) and Narrow Band Internet of Things (NB-IoT)). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example logic flow representative of a proposed scheme in accordance with the present disclosure.

FIG. 2 is a diagram of an example scenario representative of a proposed scheme in accordance with the present disclosure.

FIG. 3 is a diagram of an example scenario representative of a proposed scheme in accordance with the present disclosure.

FIG. 4 is a block diagram of an example communication environment in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to buffer status report for split bearer preprocessing in wireless communications. According to the present disclosure, a number of possible solutions may be implemented separately or jointly. That is, although these possible solutions may be described below separately, two or more of these possible solutions may be implemented in one combination or another.

In NR, buffer status report (BSR) triggering is to follow Long-Term Evolution (LTE) behavior as baseline behavior. However, there are more uplink (UL) path change scenarios compared to LTE via radio resource control (RRC) signaling configured by the network. Such scenarios can include UL split bearer mode change (e.g., between bearer duplication, bearer switching, and threshold-based aggregation), active link change in bearer switching, or user equipment (UE) detection of patch switching event (e.g., unconditional handover and/or UE-based active link switching). When the UL path change is triggered, BSR can be triggered by the network for the UE to indicate its up-to-date buffer status for network scheduling.

In LTE, BSR reporting in dual connectivity adopts a threshold-based mechanism. Since packet data convergence protocol (PDCP) indicates the data available for transmission to a prioritized medium access control (MAC) entity when the amount of the data is less than a configured split threshold, BSR reporting is only triggered in the prioritized link in this case. Only when the amount of PDCP data is equal to or greater than the configured split threshold, PDCP indicates the data available to both the prioritized MAC entity and an unprioritized MAC entity with BSR having the same buffer status reported to both prioritized and unprioritized links.

According to the 3GPP specification, when comparing with PDCP split threshold, the UE is to consider the amount of PDCP data and radio link control (RLC) pre-processed data (e.g., data pending for transmission). This can potentially be interpreted and implemented by several options. Accordingly, the present disclosure proposes a number of schemes which may be implemented individually or together in any combination of two or more of the proposed schemes.

Under a first proposed scheme in accordance with the present disclosure, PDCP preprocessing routing may be decided based on a threshold comparison. Under this scheme, the PDCP stack may submit data to two RLC entities on both the prioritized link and unprioritized link for preprocessing in an event that the amount of data in the PDCP stack is equal to or greater than a split threshold. Otherwise, the PDCP stack may submit data to the RLC entity on the prioritized link for preprocessing. When the amount of data is less than the split threshold, PDCP data may be submitted to the prioritized link and, therefore, BSR may be triggered in the prioritized link. It is believed that this scheme may ensure that data transmission is to occur through the prioritized link when the amount of data is small.

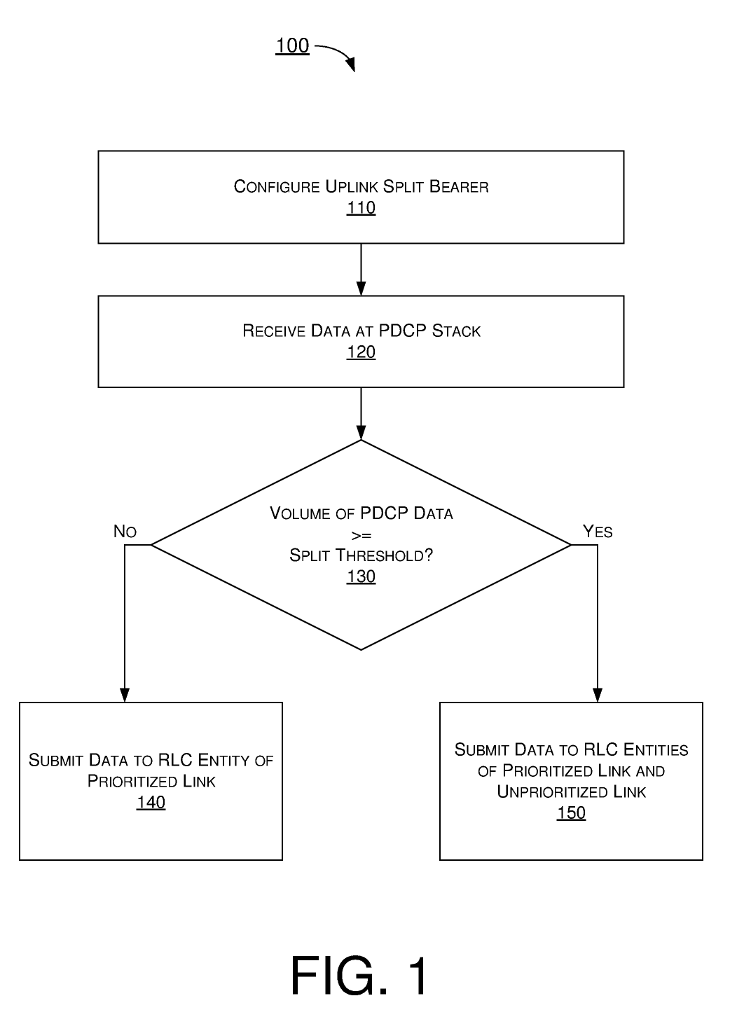

FIG. 1 illustrates an example logic flow 100 representative of the first proposed scheme in accordance with the present disclosure. Logic flow 100 may pertain to BSR for split bearer preprocessing in wireless communications. Logic flow 100 may include one or more operations, actions, or functions as represented by one or more of blocks 110, 120, 130, 140 and 150. Although illustrated as discrete blocks, various blocks of logic flow 100 may be divided into additional blocks, combined into fewer blocks, or eliminated, depending on the desired implementation. Logic flow 100 may be implemented in or by a processor of an electronic apparatus, a UE, a communication device and the like. Logic flow 100 may begin at 110.

At 110, logic flow 100 may involve configuring an UL split bearer, thereby determining a split threshold. Logic flow 100 may proceed from 110 to 120.

At 120, logic flow 100 may involve receiving data at the PDCP stack (e.g., from an upper layer). Logic flow 100 may proceed from 120 to 130.

At 130, logic flow 100 may involve comparing the volume or amount of the data in the PDCP stack to the split threshold to determine whether the amount of the data in the PDCP stack is greater than or equal to the split threshold. In an event that a result of the comparison indicates the amount of the data in the PDCP stack being less than the split threshold, logic flow 100 may proceed from 130 to 140. In an event that a result of the comparison indicates the amount of the data in the PDCP stack being greater than or equal to the split threshold, logic flow 100 may proceed from 130 to 150.

At 140, logic flow 100 may involve the PDCP stack submitting data to an RLC entity of a prioritized link for preprocessing of the data.

At 150, logic flow 100 may involve the PDCP stack submitting data to the RLC entity of the prioritized link and another RLC entity of an unprioritized link for preprocessing of the data.

Under a second proposed scheme in accordance with the present disclosure, to follow LTE behavior, buffer status size to be reported in BSR may be the total amount of data available for transmission regardless of how much data is submitted to lower layer (RLC layer and MAC layer) for preprocessing. In order to achieve such purpose, for split bearer, the PDCP stack may indicate different data amounts to the MAC entities in the prioritized and unprioritized links under this scheme.

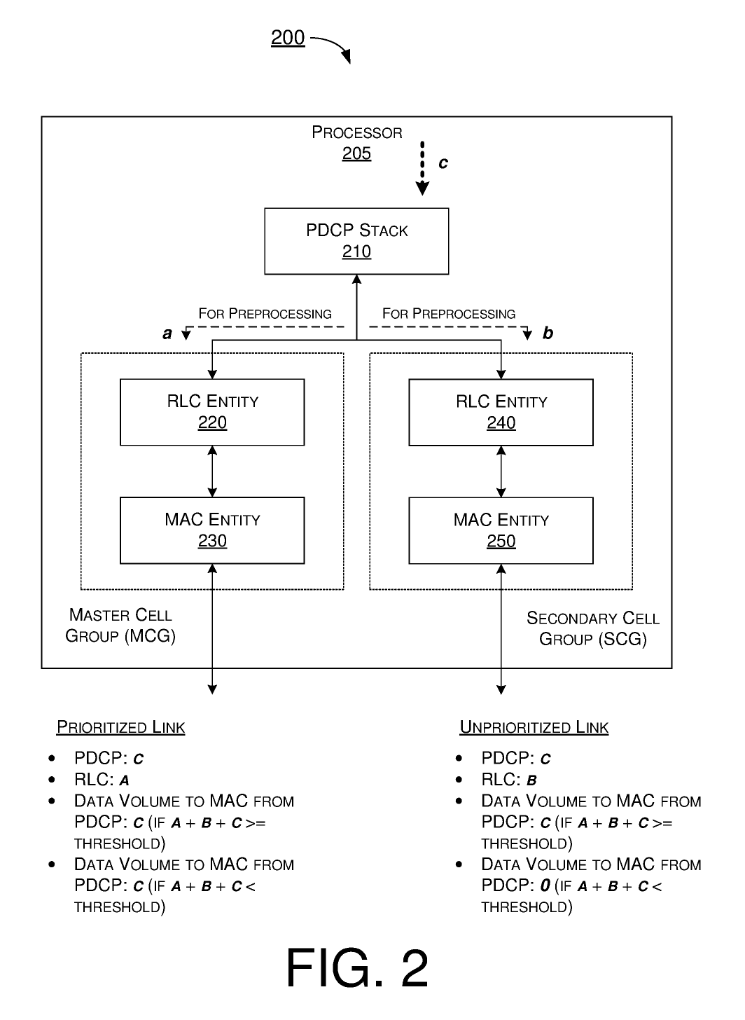

FIG. 2 illustrates an example scenario 200 representative of the second proposed scheme in accordance with the present disclosure. Example scenario 200 may take place or otherwise be implemented in a processor 205 capable of dual connectivity in wireless communication with a master cell group (MCG) and a secondary cell group (SCG) via a transceiver. Processor 205 may execute, whether by hardware, software or a combination of hardware and software, a PDCP stack 210, a primary or prioritized link including an RLC entity 220 and a MAC entity 230, and a secondary or unprioritized link including an RLC entity 240 and a MAC entity 250. The primary or prioritized link may correspond to MCG or SCG. That is, when the primary or prioritized link corresponds to MCG, the secondary or unprioritized link corresponds to SCG; when the primary or prioritized link corresponds to SCG, the secondary or unprioritized link corresponds to MCG.

Referring to FIG. 2, PDCP stack 210 may receive an amount c of data from an upper layer. PDCP stack 210 may then indicate the following: (1) an amount a of data to RLC entity 220 for preprocessing, (2) an amount b of data to RLC entity 240 for preprocessing, and (3) an amount c of unprocessed data at PDCP stack 210. To align the total amount of data available for transmission in LTE, to the respective MAC entity 230 or 250 of each of the prioritized link and the unprioritized link, PDCP stack 210 may indicate the amount of PDCP data plus the amount of preprocessed data submitted to the other link. .In an event that the sum of a+b+c is greater than or equal to a split threshold, then PDCP stack 210 may indicate c to both MAC entity 230 and MAC entity 250 (of both the prioritized link and unprioritized link). Otherwise, in an event that the sum of a+b+c is less than the split threshold, then PDCP stack 210 may indicate c to just the prioritized link but not the unprioritized link.

Under a third proposed scheme in accordance with the present disclosure, for a total amount of data available for transmission, the PDCP stack may account for the total amount of PDCP data and the amount of data that has been submitted to the RLC entities of both the prioritized and unprioritized links but not yet transmitted. In an event that the total amount of data available for transmission is less than the split threshold, the PDCP stack may indicate the amount of PDCP data to the prioritized link while indicating zero amount to the unprioritized link. The RLC entity of the prioritized link may be configured (e.g., through ul-DataSplitDRB-ViaSCG) as in LTE. However, although the PDCP stack may indicate zero to the unprioritized link (e.g., the MAC entity thereof), reporting of BSR may still be triggered when there is already preprocessed data submitted to the unprioritized link. Under this scheme, there are a few approaches to stopping the BSR in such a case.

In a first approach, the PDCP stack may retrieve data from the unprioritized link. Under this scheme, data retrieval may be implemented by the PDCP stack indicating data discard to the RLC entity of the unprioritized link. In an event that the data indicated to be discarded has not yet been transmitted (to SCG), the RLC entity of the unprioritized link may remove the data from a buffer pending for transmission as well as discount such data from the amount of RLC data.

In a second approach, the PDCP stack may issue an inactive indication to the MAC entity of the unprioritized link when the unprioritized link is configured from active state to inactive state. When the MAC entity receives the inactive indication from the upper layer (e.g., PDCP stack), the MAC entity may ensure that BSR for the logic channel indicates empty buffer status to the network.

Under a fourth proposed scheme in accordance with the present disclosure, the PDCP stack and each of the RLC entities may indicate its own amount of data (or data volume) to the MAC entities, and content of BSR may be different for both the prioritized and unprioritized links when the total amount of data for transmission is greater than or equal to the split threshold. For split bearer, a UE may preprocess a given segment of data in both the prioritized and unprioritized links. In such cases, some part of data may be preprocessed twice in different links and not transmitted until the earlier arrival of a UL grant. The buffer status reported in the MAC entities of the prioritized and unprioritized links may be different according to their individual preprocessing status.

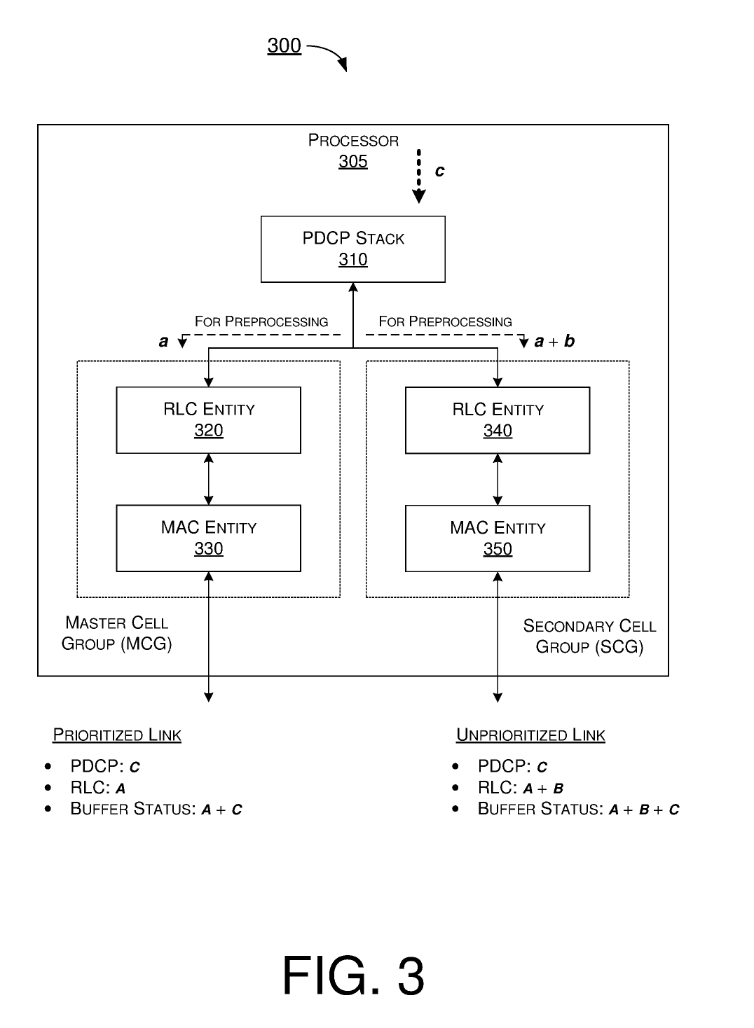

FIG. 3 illustrates an example scenario 300 representative of the fourth proposed scheme in accordance with the present disclosure. Example scenario 300 may take place or otherwise be implemented in a processor 305 capable of dual connectivity in wireless communication with a MCG and a SCG via a transceiver. Processor 305 may execute, whether by hardware, software or a combination of hardware and software, a PDCP stack 310, a primary or prioritized link including an RLC entity 320 and a MAC entity 330, and a secondary or unprioritized link including an RLC entity 340 and a MAC entity 350. The primary or prioritized link may correspond to MCG or SCG. That is, when the primary or prioritized link corresponds to MCG, the secondary or unprioritized link corresponds to SCG; when the primary or prioritized link corresponds to SCG, the secondary or unprioritized link corresponds to MCG.

Referring to FIG. 3, PDCP stack 310 may receive an amount c of data from an upper layer. PDCP stack 310 may then indicate the following: (1) an amount a of data to RLC entity 320 for preprocessing, (2) an amount a+b of data to RLC entity 340 for preprocessing, and (3) an amount c of unprocessed data at PDCP stack 310. Thus, the buffer status reported in the BSR for the prioritize link may indicate the amount a+c to the network, and the buffer status reported in the BSR for the unprioritized link may indicate the amount a+b+c to the network. This is an example of BSR when there is overlap of preprocessed data in the prioritized and unprioritized links.

Under a fifth proposed scheme in accordance with the present disclosure, the network may directly request for a precise report of preprocessing buffer status from the UE (e.g., via MAC signaling, PDCP or RRC signaling). The preprocessing buffer status may be carried in normal BSR or transmitted separately. Alternatively, the network may configure the UE to stop preprocessing in order to better predict and/or schedule UL data. The configuration of the UE by the network may be done through RRC signaling, PDCP control protocol data unit (PDU) or MAC control element (CE). As an alternative option, the UE may indicate whether the preprocessing is in operation in BSR. The indication may further contain information as to whether preprocessing is in operation in another link for split bearer.

### Illustrative Implementations

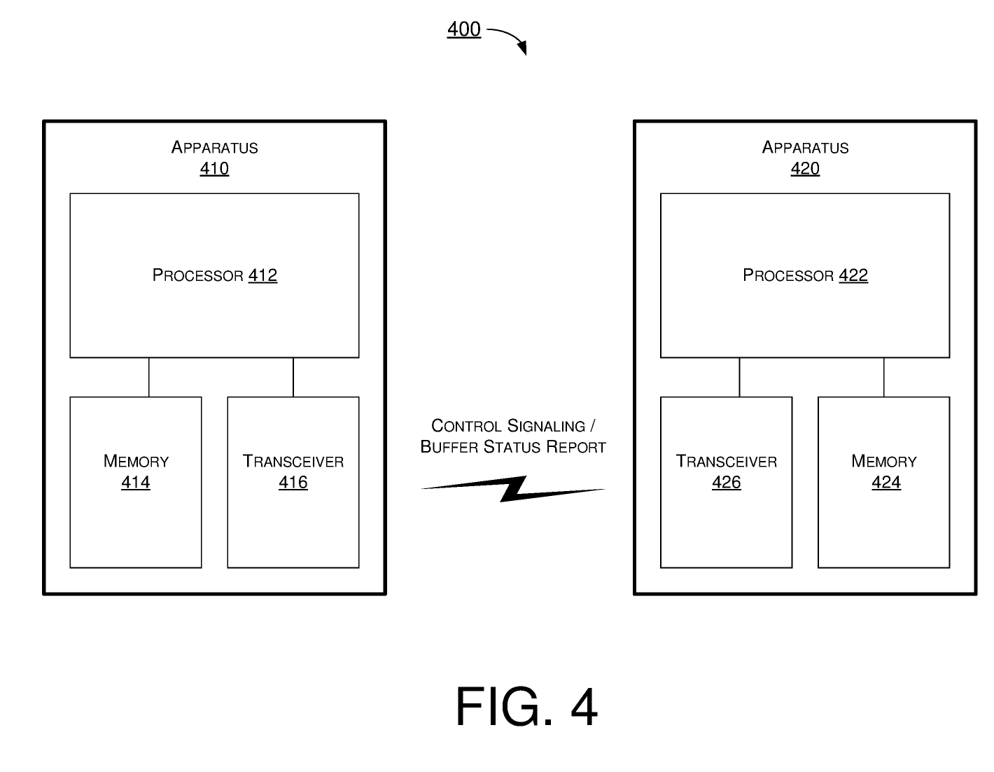

FIG. 4 illustrates an example communication environment 400 having an example apparatus 410 and an example apparatus 420 in accordance with an implementation of the present disclosure. Each of apparatus 410 and apparatus 420 may perform various functions to implement schemes, techniques, processes and methods described herein pertaining to buffer status report for split bearer preprocessing in wireless communications, including various schemes described above as well as processes 500 and 600 described below.

Each of apparatus 410 and apparatus 420 may be a part of an electronic apparatus, which may be a user equipment (UE) such as a portable or mobile apparatus, a wearable apparatus, a wireless communication apparatus or a computing apparatus. For instance, each of apparatus 410 and apparatus 420 may be implemented in a smartphone, a smartwatch, a personal digital assistant, a digital camera, or a computing equipment such as a tablet computer, a laptop computer or a notebook computer. Each of apparatus 410 and apparatus 420 may also be a part of a machine type apparatus, which may be an IoT or NB-IoT apparatus such as an immobile or a stationary apparatus, a home apparatus, a wire communication apparatus or a computing apparatus. For instance, each of apparatus 410 and apparatus 420 may be implemented in a smart thermostat, a smart fridge, a smart door lock, a wireless speaker or a home control center.

Alternatively, each of apparatus 410 and apparatus 420 may be implemented in the form of one or more integrated-circuit (IC) chips such as, for example and without limitation, one or more single-core processors, one or more multi-core processors, or one or more complex-instruction-set-computing (CISC) processors. Each of apparatus 410 and apparatus 420 may include at least some of those components shown in FIG. 4 such as a processor 412 and a processor 422, respectively. Each of apparatus 410 and apparatus 420 may further include one or more other components not pertinent to the proposed scheme of the present disclosure (e.g., internal power supply, display device and/or user interface device), and, thus, such component(s) of each of apparatus 410 and apparatus 420 are neither shown in FIG. 4 nor described below in the interest of simplicity and brevity.

In some implementations, at least one of apparatus 410 and apparatus 420 may be a part of an electronic apparatus, which may be a network node such as a transmit/receive point (TRP), a base station, a small cell, a router or a gateway. For instance, at least one of apparatus 410 and apparatus 420 may be implemented in an eNodeB in an LTE, LTE-Advanced or LTE-Advanced Pro network or in a gNB in a 5G, NR, IoT or NB-IoT network. Alternatively, at least one of apparatus 410 and apparatus 420 may be implemented in the form of one or more IC chips such as, for example and without limitation, one or more single-core processors, one or more multi-core processors, or one or more CISC processors.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including buffer status report for split bearer preprocessing in wireless communications in accordance with various implementations of the present disclosure.

In some implementations, apparatus 410 may also include a transceiver 416 coupled to processor 412 and capable of wirelessly transmitting and receiving data. In some implementations, apparatus 410 may further include a memory 414 coupled to processor 412 and capable of being accessed by processor 412 and storing data therein. In some implementations, apparatus 420 may also include a transceiver 426 coupled to processor 422 and capable of wirelessly transmitting and receiving data. In some implementations, apparatus 420 may further include a memory 424 coupled to processor 422 and capable of being accessed by processor 422 and storing data therein. Accordingly, apparatus 410 and apparatus 420 may wirelessly communicate with each other via transceiver 416 and transceiver 426, respectively.

To aid better understanding, the following description of the operations, functionalities and capabilities of each of apparatus 410 and apparatus 420 is provided in the context of a mobile communication environment in which apparatus 410 is implemented in or as a wireless communication device, a communication apparatus or a UE and apparatus 420 is implemented in or as a network node (e.g., base station) of a mobile communication system. Accordingly, processor 412 of apparatus 410 may be an example implementation of processor 205 of example scenario 200 and/or processor 305 of example scenario 300. Moreover, processor 412 may be configured, designed or otherwise adapted to implement each of the proposed schemes individually or two or more of the proposed schemes in any combination in accordance with the present disclosure. Thus, although not shown in FIG. 4, processor 412 may execute or otherwise render, whether by hardware, software or a combination of hardware and software, a PDCP stack, a primary or prioritized link including an RLC entity and a MAC entity, and a secondary or unprioritized link including an RLC entity and a MAC entity. The primary or prioritized link may correspond to MCG or SCG. That is, when the primary or prioritized link corresponds to MCG, the secondary or unprioritized link corresponds to SCG; when the primary or prioritized link corresponds to SCG, the secondary or unprioritized link corresponds to MCG.

In one aspect under one or more proposed schemes in accordance with the present disclosure, processor 412 of apparatus 410 may perform a number of operations pertaining to buffer status report for split bearer preprocessing in wireless communications. For instance, processor 412 may perform the following: (1) receiving, via transceiver 416, control signaling from a mobile communication system through apparatus 420 as a network node (e.g., gNB or TRP); (2) configuring, based on the control signaling, a PDCP entity to be associated with two and RLC entities comprising a primary RLC entity and a secondary RLC entity; (3) preprocessing data; (4) comparing a total amount of data available for transmission, including a total amount of PDCP data volume and RLC data volume pending for initial transmission in the two associated RLC entities, to a threshold (e.g., split threshold); (5) performing either a first procedure, responsive to the comparing showing the total amount of data available for transmission being less than the threshold, or a second procedure, responsive to the comparing showing the total amount of data available for transmission being greater than or equal to the threshold. With respect to the first procedure, processor 412 may indicate an amount of the PDCP data volume to a first MAC entity associated with the primary RLC entity. Additionally, processor 412 may indicate zero to a second MAC entity associated with the secondary RLC entity. With respect to the second procedure, processor 412 may indicate the amount of the PDCP data volume to both the first MAC entity and the second MAC entity.

In some implementations, the first procedure may further involve processor 412 retrieving pending data from the secondary RLC entity.

In some implementations, in retrieving the pending data from the secondary RLC entity, processor 412 may perform a number of operations. For instance, processor 412 may indicate, by a PDCP stack to the secondary RLC entity, discard of the pending data. Moreover, processor 412 may remove, by the secondary RLC entity, the pending data from a buffer for transmission such that the removed pending data is excluded in determining the total amount of data available for transmission.

In some implementations, in retrieving the pending data from the secondary RLC entity, processor 412 may perform a number of operations. For instance, within processor 412, a PDCP stack may transmit to the second MAC entity an inactive indication. Additionally, processor 412 may retrieve a BSR previously generated.

In some implementations, in preprocessing the data, processor 412 may performing some additional operations. For instance, processor 412 may submit, by a PDCP stack, the data to a primary link and a secondary link. The primary link may include the primary RLC entity and the first MAC entity. The secondary link may include the secondary RLC entity and the second MAC entity. Additionally, processor 412 may process, by the primary link and the secondary link, the data prior to receiving an UL grant from apparatus 420.

In some implementations, processor 412 may also configure, based on the control signaling, the primary RLC entity as an RLC leg associated to a prioritized link. Moreover, the secondary RLC entity may be an RLC leg associated to an unprioritized link. Additionally, the first and second MAC entities and the primary and secondary RLC entities may be associated with a MCG or a SCG by network configuration in a dual connectivity scenario.

In some implementations, processor 412 may perform some additional operations. For instance, processor 412 may generate a BSR indicating the total amount of data available for transmission. Additionally, processor 412 may transmit, via transceiver 416, the BSR to apparatus 420. Moreover, processor 412 may receive, via transceiver 416, an UL grant from apparatus 420. Furthermore, processor 412 may transmit, via transceiver 416, at least the preprocessed data to apparatus 420 responsive to receiving the UL grant.

In another aspect under one or more proposed schemes in accordance with the present disclosure, processor 412 of apparatus 410 may perform a number of operations pertaining to buffer status report for split bearer preprocessing in wireless communications. For instance, processor 412 may determine a total amount of data available for transmission, which may include a total amount of PDCP data volume and RLC data volume pending for initial transmission in two associated RLC entities comprising a primary RLC entity and a secondary RLC entity. Additionally, processor 412 may compare the total amount of data available for transmission to a threshold (e.g., split threshold). In response to the total amount of data available for transmission less than the threshold, processor 412 may report to apparatus 420, via transceiver 416, to indicate that there is data for transmission to a first cell group and there is no data for transmission to a second cell group. In response to the total amount of data available for transmission greater than or equal to the threshold, processor 412 may report to apparatus 420, via transceiver 416, to indicate that there is data for transmission to both the first cell group and the second cell group.

In some implementations, processor 412 may perform some additional operations. For instance, in response to the total amount of data available for transmission less than the threshold, processor 412 may perform the following: (1) indicating an amount of PDCP data volume to a first MAC entity associated with the primary RLC entity; and (2) indicating zero to a second MAC entity associated with the secondary RLC entity. Moreover, in response to the total amount of data available for transmission greater than or equal to the threshold, processor 412 may indicate the amount of the PDCP data volume to both the first MAC entity and the second MAC entity.

In some implementations, in response to the total amount of data available for transmission less than the threshold, processor 412 may perform additional operations. For instance, processor 412 may perform the following: (1) indicating, by a PDCP stack to the secondary RLC entity, discard of the pending data; and (2) removing, by the secondary RLC entity, the pending data from a buffer for transmission such that the removed pending data is excluded in determining the total amount of data available for transmission.

In some implementations, in response to the total amount of data available for transmission less than the threshold, within processor 412 a PDCP stack may transmit to the second MAC entity an inactive indication. Moreover, in reporting to apparatus 420, processor 412 may retrieve a BSR previously generated.

In some implementations, processor 412 may also receive, via transceiver 416, control signaling from apparatus 420 that configures the primary RLC entity as an RLC leg associated to a prioritized link. Moreover, the secondary RLC entity may be an RLC leg associated to an unprioritized link. Additionally, the first and second MAC entities and the primary and secondary RLC entities may be associated with a MCG or a SCG by network configuration in a dual connectivity scenario.

In some implementations, processor 412 may perform some other additional operations. For instance, processor 412 may submit, by a PDCP stack, data to a primary link and a secondary link. The primary link may include the primary RLC entity and the first MAC entity. The secondary link may include the secondary RLC entity and the second MAC entity. Additionally, processor 412 may process, by the primary link and the secondary link, the data prior to receiving an UL grant from apparatus 420.

### Illustrative Processes

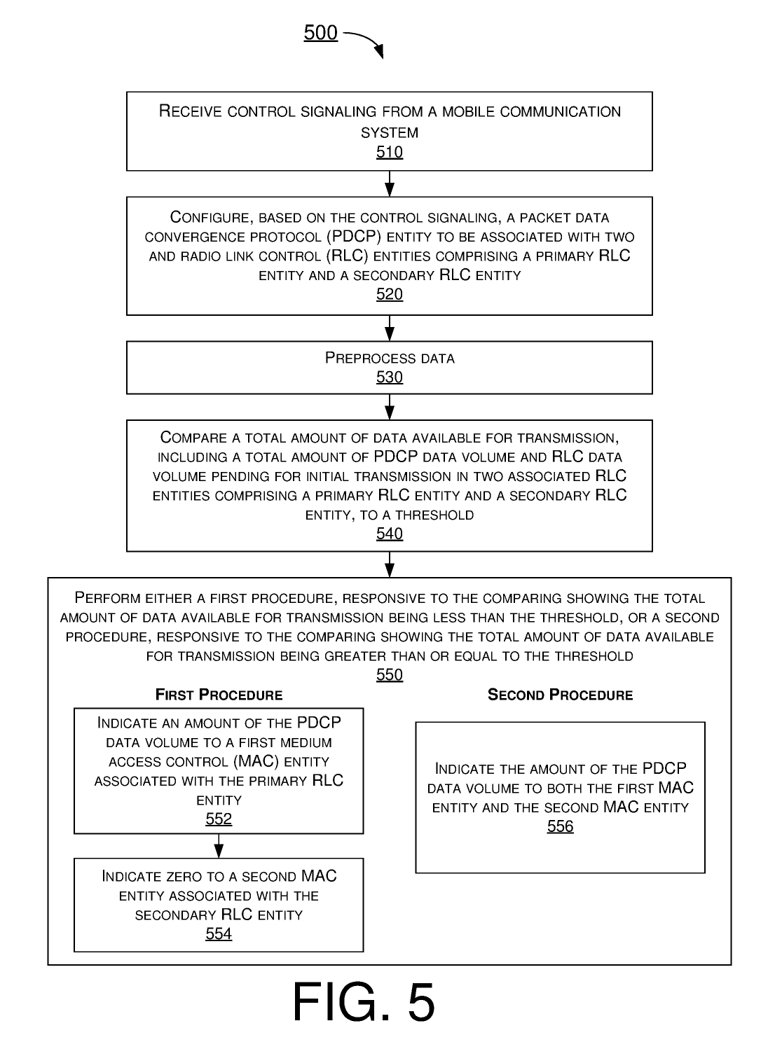

FIG. 5 illustrates an example process 500 in accordance with an implementation of the present disclosure. Process 500 may be an example implementation of one or more of the proposed schemes described above with respect to buffer status report for split bearer preprocessing in wireless communications in accordance with the present disclosure. Process 500 may represent an aspect of implementation of features of apparatus 410 and/or apparatus 420. Process 500 may include one or more operations, actions, or functions as illustrated by one or more of blocks 510, 520, 530, 540 and 550 as well as sub-blocks 552, 554 and 556. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may also be repeated partially or entirely. Process 500 may be implemented by apparatus 410, apparatus 420 and/or any suitable wireless communication device, UE, base station or machine type devices. Solely for illustrative purposes and without limitation, process 500 is described below in the context of apparatus 410 as a UE and apparatus 420 as a network node (e.g., gNB) of a mobile communication system (e.g., 5G/NR mobile network). Process 500 may begin at block 510.

At 510, process 500 may involve processor 412 of apparatus 410 receiving, via transceiver 416, control signaling from a mobile communication system through apparatus 420. Process 500 may proceed from 510 to 520.

At 520, process 500 may involve processor 412 configuring, based on the control signaling, a PDCP entity to be associated with two RLC entities comprising a primary RLC entity and a secondary RLC entity. Process 500 may proceed from 520 to 530.

At 530, process 500 may involve processor 412 of apparatus 410 preprocessing data. Process 500 may proceed from 530 to 540.

At 540, process 500 may involve processor 412 comparing a total amount of data available for transmission, including a total amount of PDCP data volume and RLC data volume pending for initial transmission in the two associated RLC entities, to a threshold (e.g., split threshold). Process 500 may proceed from 540 to 550.

At 550, process 500 may involve processor 412 performing either a first procedure, responsive to the comparing showing the total amount of data available for transmission being less than the threshold, or a second procedure, responsive to the comparing showing the total amount of data available for transmission being greater than or equal to the threshold.

The first procedure may be represented by sub-blocks 552 and 554, and the second procedure may be represented by sub-bock 556.

At 552, process 500 may involve processor 412 indicating an amount of the PDCP data volume to a first MAC entity associated with the primary RLC entity. Process 500 may proceed from 552 to 554.

At 554, process 500 may involve processor 412 indicating zero to a second MAC entity associated with the secondary RLC entity.

At 556, process 500 may involve processor 412 indicating the amount of the PDCP data volume to both the first MAC entity and the second MAC entity.

In some implementations, the first procedure may further involve processor 412 retrieving pending data from the secondary RLC entity.

In some implementations, in retrieving the pending data from the secondary RLC entity, process 500 may involve processor 412 performing a number of operations. For instance, process 500 may involve processor 412 indicating, by a PDCP stack to the secondary RLC entity, discard of the pending data. Moreover, process 500 may involve processor 412 removing, by the secondary RLC entity, the pending data from a buffer for transmission such that the removed pending data is excluded in determining the total amount of data available for transmission.

In some implementations, in retrieving the pending data from the secondary RLC entity, process 500 may involve processor 412 performing a number of operations. For instance, process 500 may involve processor 412 transmitting, by a PDCP stack to the second MAC entity, an inactive indication. Additionally, process 500 may involve processor 412 retrieving a BSR previously generated.

In some implementations, in preprocessing the data, process 500 may further involve processor 412 performing a number of operations. For instance, process 500 may involve processor 412 submitting, by a PDCP stack, the data to a primary link and a secondary link. The primary link may include the primary RLC entity and the first MAC entity. The secondary link may include the secondary RLC entity and the second MAC entity. Additionally, process 500 may involve processor 412 processing, by the primary link and the secondary link, the data prior to receiving an UL grant from apparatus 420.

In some implementations, process 500 may further involve processor 412 configuring, based on the control signaling, the primary RLC entity as an RLC leg associated to a prioritized link. Moreover, the secondary RLC entity may be an RLC leg associated to an unprioritized link. Additionally, the first and second MAC entities and the primary and secondary RLC entities may be associated with a MCG or a SCG by network configuration in a dual connectivity (DC) scenario.

In some implementations, process 500 may further involve processor 412 performing a number of operations. For instance, process 500 may involve processor 412 generating a BSR indicating the total amount of data available for transmission. Additionally, process 500 may involve processor 412 transmitting the BSR to apparatus 420. Moreover, process 500 may involve processor 412 receiving an UL grant from apparatus 420. Furthermore, process 500 may involve processor 412 transmitting at least the preprocessed data to apparatus 420 responsive to receiving the UL grant.

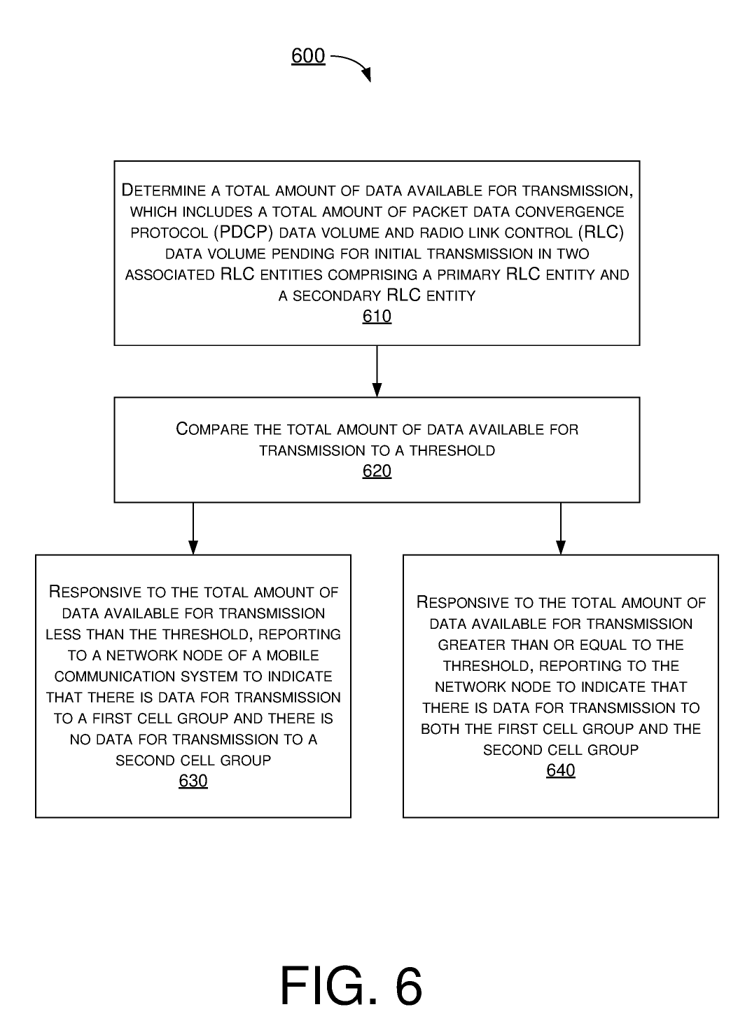

FIG. 6 illustrates an example process 600 in accordance with an implementation of the present disclosure. Process 600 may be an example implementation of one or more of the proposed schemes described above with respect to buffer status report for split bearer preprocessing in wireless communications in accordance with the present disclosure. Process 600 may represent an aspect of implementation of features of apparatus 410 and/or apparatus 420. Process 600 may include one or more operations, actions, or functions as illustrated by one or more of blocks 610, 620, 630 and 640. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may also be repeated partially or entirely. Process 600 may be implemented by apparatus 410, apparatus 420 and/or any suitable wireless communication device, UE, base station or machine type devices. Solely for illustrative purposes and without limitation, process 600 is described below in the context of apparatus 410 as a UE and apparatus 420 as a network node (e.g., gNB) of a mobile communication system (e.g., 5G/NR mobile network). Process 600 may begin at block 610.

At 610, process 600 may involve processor 412 of apparatus 410 determining a total amount of data available for transmission, which may include a total amount of PDCP data volume and RLC data volume pending for initial transmission in two associated RLC entities comprising a primary RLC entity and a secondary RLC entity. Process 600 may proceed from 610 to 620.

At 620, process 600 may involve processor 412 comparing the total amount of data available for transmission to a threshold (e.g., split threshold). Depending on a result of the comparison, process 600 may proceed from 620 to either 630 or 640.

At 630, in response to the total amount of data available for transmission less than the threshold, process 600 may involve processor 412 reporting to apparatus 420 to indicate that there is data for transmission to a first cell group and there is no data for transmission to a second cell group.

At 640, in response to the total amount of data available for transmission greater than or equal to the threshold, process 600 may involve processor 412 reporting to apparatus 420 to indicate that there is data for transmission to both the first cell group and the second cell group.

In some implementations, process 600 may also involve processor 412 performing additional operations. For instance, in response to the total amount of data available for transmission less than the threshold, process 600 may also involve processor 412 performing the following: (1) indicating an amount of PDCP data volume to a first MAC entity associated with the primary RLC entity; and (2) indicating zero to a second MAC entity associated with the secondary RLC entity. Moreover, in response to the total amount of data available for transmission greater than or equal to the threshold, process 600 may also involve processor 412 indicating the amount of the PDCP data volume to both the first MAC entity and the second MAC entity.

In some implementations, in response to the total amount of data available for transmission less than the threshold, process 600 may also involve processor 412 performing additional operations. For instance, process 600 may also involve processor 412 performing the following: (1) indicating, by a PDCP stack to the secondary RLC entity, discard of the pending data; and (2) removing, by the secondary RLC entity, the pending data from a buffer for transmission such that the removed pending data is excluded in determining the total amount of data available for transmission.

In some implementations, in response to the total amount of data available for transmission less than the threshold, process 600 may further involve processor 412 transmitting, by a PDCP stack to the second MAC entity, an inactive indication. Moreover, in reporting to apparatus 420, process 600 may involve processor 412 retrieving a BSR previously generated.

In some implementations, process 600 may further involve processor 412 receiving control signaling from apparatus 420 that configures the primary RLC entity as an RLC leg associated to a prioritized link. Moreover, the secondary RLC entity may be an RLC leg associated to an unprioritized link. Additionally, the first and second MAC entities and the primary and secondary RLC entities may be associated with a MCG or a SCG by network configuration in a dual connectivity (DC) scenario.

In some implementations, process 600 may also involve processor 412 performing additional operations. For instance, process 600 may involve processor 412 submitting, by a PDCP stack, data to a primary link and a secondary link. The primary link may include the primary RLC entity and the first MAC entity. The secondary link may include the secondary RLC entity and the second MAC entity. Additionally, process 600 may involve processor 412 processing, by the primary link and the secondary link, the data prior to receiving an UL grant from apparatus 420.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving control signaling from a mobile communication system;
configuring, based on the control signaling, a packet data convergence protocol (PDCP) entity to be associated with two and radio link control (RLC) entities comprising a primary RLC entity and a secondary RLC entity;
preprocessing data;
comparing a total amount of data available for transmission, including a total amount of PDCP data volume and RLC data volume pending for initial transmission in the two associated RLC entities, to a threshold; and
performing either a first procedure, responsive to the comparing showing the total amount of data available for transmission being less than the threshold, or a second procedure, responsive to the comparing showing the total amount of data available for transmission being greater than or equal to the threshold,
wherein the first procedure comprises:
indicating an amount of the PDCP data volume to a first medium access control (MAC) entity associated with the primary RLC entity; and
indicating zero to a second MAC entity associated with the secondary RLC entity, and
wherein the second procedure comprises:
indicating the amount of the PDCP data volume to both the first MAC entity and the second MAC entity.

2. The method of claim 1, wherein the first procedure further comprises retrieving pending data from the secondary RLC entity.

3. The method of claim 2, wherein the retrieving of the pending data from the secondary RLC entity comprises:
indicating, by a PDCP stack to the secondary RLC entity, discard of the pending data; and
removing, by the secondary RLC entity, the pending data from a buffer for transmission such that the removed pending data is excluded in determining the total amount of data available for transmission.

4. The method of claim 2, wherein the retrieving of the pending data from the secondary RLC entity comprises:
transmitting, by a PDCP stack to the second MAC entity, an inactive indication; and
retrieving a buffer status report (BSR) previously generated.

5. The method of claim 1, wherein the preprocessing the data comprises:
submitting, by a PDCP stack, the data to a primary link and a secondary link, the primary link comprising the primary RLC entity and the first MAC entity, the secondary link comprising the secondary RLC entity and the second MAC entity; and
processing, by the primary link and the secondary link, the data prior to receiving an uplink (UL) grant from a network node of a mobile communication system.

6. The method of claim 1, wherein the control signaling further configures the primary RLC entity as an RLC leg associated to a prioritized link, wherein the secondary RLC entity is an RLC leg associated to an unprioritized link, and wherein the first and second MAC entities and the primary and the secondary RLC entities are associated with a master cell group (MCG) or a secondary cell group (SCG) in a dual connectivity (DC) scenario.

7. The method of claim 1, further comprising:
generating a buffer status report (BSR) indicating the total amount of data available for transmission;
transmitting the BSR to a network node of a mobile communication system;
receiving an uplink (UL) grant from the network node; and
transmitting at least the preprocessed data to the network node responsive to receiving the UL grant.

8. A method, comprising:
determining a total amount of data available for transmission, which includes a total amount of packet data convergence protocol (PDCP) data volume and radio link control (RLC) data volume pending for initial transmission in two associated RLC entities comprising a primary RLC entity and a secondary RLC entity;
comparing the total amount of data available for transmission to a threshold; and
either:
responsive to the total amount of data available for transmission less than the threshold, reporting to a network node of a mobile communication system to indicate that there is data for transmission to a first cell group and there is no data for transmission to a second cell group; or
responsive to the total amount of data available for transmission greater than or equal to the threshold, reporting to the network node to indicate that there is data for transmission to both the first cell group and the second cell group.

9. The method of claim 8, further comprising:
responsive to the total amount of data available for transmission less than the threshold:
indicating an amount of PDCP data volume to a first medium access control (MAC) entity associated with the primary RLC entity; and
indicating zero to a second MAC entity associated with the secondary RLC entity, and
responsive to the total amount of data available for transmission greater than or equal to the threshold:
indicating the amount of the PDCP data volume to both the first MAC entity and the second MAC entity.

10. The method of claim 9, responsive to the total amount of data available for transmission less than the threshold, further comprising:
indicating, by a PDCP stack to the secondary RLC entity, discard of the pending data; and
removing, by the secondary RLC entity, the pending data from a buffer for transmission such that the removed pending data is excluded in determining the total amount of data available for transmission.

11. The method of claim 9, responsive to the total amount of data available for transmission less than the threshold, further comprising:
transmitting, by a PDCP stack to the second MAC entity, an inactive indication,
wherein the reporting to the network node comprises retrieving a buffer status report (BSR) previously generated.

12. The method of claim 9, further comprising:
receiving control signaling from the mobile communication system that configures the primary RLC entity as an RLC leg associated to a prioritized link,
wherein the secondary RLC entity is an RLC leg associated to an unprioritized link,
wherein the first MAC entity and the primary RLC entity are associated with a master cell group (MCG) or a secondary cell group (SCG) in a dual connectivity (DC) scenario, and
wherein the second MAC entity and the secondary RLC entity are associated with another of the MCG or the SCG in the dual connectivity scenario.

13. The method of claim 8, further comprising:
submitting, by a PDCP stack, data to a primary link and a secondary link, the primary link comprising the primary RLC entity and the first MAC entity, the secondary link comprising the secondary RLC entity and the second MAC entity; and
processing, by the primary link and the secondary link, the data prior to receiving an uplink (UL) grant from a network node of a mobile communication system.

14. An apparatus, comprising:
a transceiver capable of wirelessly communicating with a mobile communication system; and
a processor coupled to the transceiver, the processor capable of:
receiving, via the transceiver, control signaling from the mobile communication system;
configuring, based on the control signaling, a packet data convergence protocol (PDCP) entity to be associated with two and radio link control (RLC) entities comprising a primary RLC entity and a secondary RLC entity;
preprocessing data;
comparing a total amount of data available for transmission, including a total amount of PDCP data volume and RLC data volume pending for initial transmission in the two associated RLC entities, to a threshold; and
performing either a first procedure, responsive to the comparing showing the total amount of data available for transmission being less than the threshold, or a second procedure, responsive to the comparing showing the total amount of data available for transmission being greater than or equal to the threshold,
wherein the first procedure comprises:
indicating an amount of the PDCP data volume to a first medium access control (MAC) entity associated with the primary RLC entity; and
indicating zero to a second MAC entity associated with the secondary RLC entity, and
wherein the second procedure comprises:
indicating the amount of the PDCP data volume to both the first MAC entity and the second MAC entity.

15. The apparatus of claim 14, wherein the first procedure further comprises retrieving pending data from the secondary RLC entity.

16. The apparatus of claim 15, wherein, in retrieving the pending data from the secondary RLC entity, the processor is capable of performing operations comprising:
indicating, by a PDCP stack to the secondary RLC entity, discard of the pending data; and
removing, by the secondary RLC entity, the pending data from a buffer for transmission such that the removed pending data is excluded in determining the total amount of data available for transmission.

17. The apparatus of claim 15, wherein, in retrieving the pending data from the secondary RLC entity, the processor is capable of performing operations comprising:
transmitting, by a PDCP stack to the second MAC entity, an inactive indication; and
retrieving a buffer status report (BSR) previously generated.

18. The apparatus of claim 14, wherein, in preprocessing the data, the processor is capable of performing operations comprising:
submitting, by a PDCP stack, the data to a primary link and a secondary link, the primary link comprising the primary RLC entity and the first MAC entity, the secondary link comprising the secondary RLC entity and the second MAC entity; and
processing, by the primary link and the secondary link, the data prior to receiving an uplink (UL) grant from a network node of a mobile communication system.

19. The apparatus of claim 14, wherein the processor is further capable of performing operations comprising:
configuring, based on the control signaling, the primary RLC entity as an RLC leg associated to a prioritized link,
wherein the secondary RLC entity is an unprioritized RLC leg associated to an unprioritized link, and
wherein the first and second MAC entities and the primary and secondary RLC entities are associated with a master cell group (MCG) or a secondary cell group (SCG) in a dual connectivity (DC) scenario.

20. The apparatus of claim 14, wherein the processor is further capable of performing operations comprising:
generating a buffer status report (BSR) indicating the total amount of data available for transmission;
transmitting the BSR to a network node of a mobile communication system;
receiving an uplink (UL) grant from the network node; and
transmitting at least the preprocessed data to the network node responsive to receiving the UL grant.
